(19) United States
(12) Patent Application Publication
(10) Pub. No.: US 2010/0031574 A1
(43) Pub. Date: Feb. 11, 2010

(54) Rail element and door drive

(76) Inventor: Michael Hormann, Halle/Westf. (DE)

Correspondence Address: DILWORTH & BARRESE, LLP, 1000 WOODBURY ROAD, SUITE 405, WOODBURY, NY, 11797, US

(21) Appl. No.: 12/288,179

(22) Filed: Oct. 17, 2008

(30) Foreign Application Priority Data
Oct. 19, 2007 (DE) UM 202007014675.2

(51) Int. Cl. E05F 15/00

(52) U.S. Cl. 49/199

(57) ABSTRACT

The present invention relates to a rail element for a door drive, in particular of a garage door, comprising a rail and a drive means, in particular a chain or a toothed belt, wherein at a deflection end of the rail element a deflection pulley and at a drive end of the rail element a drive wheel are provided, via which the drive means is circulated, so that the drive means extends within the rail in two counterrotating strands, wherein one of the strands of the drive means is guided from the drive wheel via a deflection element into the rail, so that the distance of the two counterrotating strands of the drive means within the rail is smaller than the diameter of the drive wheel.

The present invention relates to a rail element for a door drive, in particular of a garage door, comprising a rail and a drive means, in particular a chain or a toothed belt, wherein at a deflection end of the rail element a deflection pulley and at a drive end of the rail element a drive wheel are provided, via which the drive means is circulated, so that the drive means extends within the rail in two counterrotating strands. For this purpose, the rail of the rail element is arranged between the deflection end of the rail element and the drive end of the rail element.

Furthermore, the present invention relates to a door drive with such a rail element,

Such rail elements usually are employed to open and close a door, in particular a garage door, by means of the door drive. For this purpose, a carriage is provided, which can be shifted in the usually C-shaped rail and is connected with one of the two parallel strands of the drive means, so that the carriage is moved along the rail during a movement of the drive means. Furthermore, a cam usually is disposed on the carriage, which is connected with the door and thus opens and closes the door.

Furthermore, a drive motor which moves the drive wheel usually is connected with the drive wheel of the rail element, wherein the drive means is circulated in the rail by a rotation of the drive wheel, so that the two parallel strands of the drive means in the rail move in opposite directions.

Such rail element for a door drive, in which a toothed belt is used as drive means, is known for instance from DE 780 17 016 U1. In the rail, the two strands of the drive means extend parallel to an imaginary connecting line between the axes of rotation of drive wheel and deflection pulley, namely with a distance to the imaginary connecting line, which corresponds to the deflection radius of the drive means about the drive wheel and/or deflection pulley. Drive means such as a roller chain or a toothed belt, however, have a minimum radius, which determines the diameter of the drive wheel and/or deflection pulley, since the radius of the drive wheel and/or delection pulley must be at least as large as the minimum radius of the drive means. In conventional drives, the width of the rail hence is determined by the minimum radius of the drive means, since the distance of the two strands within the rail corresponds to the diameter of drive wheel and/or deflection pulley. In addition, the drive wheel neither can be designed as small as desired independent of the minimum radius of the drive means, in order to ensure a reliable power transmission from the drive wheel to the drive means.

It is the object of the present invention to provide for a narrower profile of the rail.

In accordance with the invention, this object is solved by a rail element according to claim 1. Such rail element for a door drive, in particular of a garage door, includes a rail and a drive means, in particular a chain or a toothed belt, wherein at a deflection end of the rail element a deflection pulley and at a drive end of the rail element a drive wheel are provided, via which the drive means is circulated, so that the drive means extends in two counterrotating strands within the rail. In accordance with the invention it now is provided in such rail element that one of the strands of the drive means is guided from the drive wheel via a deflection element into the rail, so that the distance of the two counterrotating strands of the drive means within the rail is smaller than the diameter of the drive wheel. The rear side of the drive means contacts the deflection element in a region whose distance from the imaginary connecting line between the axis of rotation of the drive wheel and the deflection pulley is smaller than the radius of circulation of the rear side of the deflection means about the drive wheel.

Despite a large minimum radius of the drive means and despite a large drive wheel, a very narrow rail therefore can be used for the safe transmission of the driving force to the drive means, since the two strands of the drive means extending in parallel within the rail no longer must have a distance from each other which is determined by the radius of circulation about the drive wheel, as in the prior art, but are guided closer to each other by the deflection element. At the same time, a large circulation radius and nevertheless a very narrow rail can be realized thereby. The narrow rail provides for compact drives and packages and hence for an easy transport and unproblematic assembly. Due to the compact construction, the drive system comprising the rail element and the drive motor also can be premounted and be utilized as a component for various door drives.

Furthermore advantageously, it is provided that the other strand of the drive means extends directly from the drive wheel into the rail without a deflection element. In this arrangement, the one strand extends within the rail along a straight line, which has a distance from the axis of rotation of the drive wheel smaller than the radius of circulation of the drive means about the drive wheel, so that it must be deflected by the deflection element between the end of the rail and the drive wheel, whereas the other strand extends on a straight line which tangentially meets with the drive wheel and whose distance from the axis of rotation of the drive wheel hence exactly corresponds to the radius of circulation of the drive means. Due to the fact that only one of the strands is guided closer to the other strand via a deflection element, whereas the other strand straightaway moves towards the drive wheel, friction losses can be minimized in the arrangement of the invention. Due to this asymmetric configuration of the drive means guideway of the invention, the low friction losses of the drives known from the prior art can be combined with a considerably narrower rail in accordance with the invention. Due to the asymmetric configuration only one deflection point is required, which can be designed such that there is no significant increase in losses as compared to the prior art.

Furthermore advantageously, in a region adjoining the deflection element a separating element is provided between the two counterrotating strands. Since in this region the two strands are guided closer to each other by the deflection element, this would involve an increased risk for mutual contact and a resulting entanglement of the two strands of the drive means without the separating element. Due to the separating element, which can be formed for instance by a partition between tight side and slack side, the two strands guided closer to each other cannot come in contact with each other. In this way, it also is safely avoided that e.g. the teeth of a toothed belt used as drive means are entangled with each other. It is sufficient, when the separating element only is provided in a certain region subsequent to the deflection element, since the two strands extend in parallel within the rail and thus are less susceptible to entanglement.

Furthermore advantageously, the drive wheel, the deflection element and possibly the separating element are arranged in a common housing in the rail element of the invention. This provides a simple and compact assembly of drive wheel and deflection element and possibly separating element. The housing advantageously also includes a receptacle for accommodating a rail end. For instance, the rail end advantageously can be inserted into the receptacle or be pushed onto the receptacle, in order to simply attach the housing to the rail. In this way, the rail element can easily be mounted by connecting the rail with the assembly of drive wheel and deflection element and possibly separating element.

Furthermore advantageously, the deflection side of the rail element of the invention also is constructed analogous to the drive side. Advantageously, one of the strands of the drive means is guided from the deflection pulley via a deflection-side deflection element into the rail, so that the distance of the two counterrotating strands of the drive means within the rail is smaller than the diameter of the deflection pulley. If the minimum radius of the drive means is greater than half of the desired distance of the two strands of the drive means within the rail, such arrangement is necessary, so as not fall below this minimum radius on the deflection side either.

Deflection pulley and drive wheel can for instance have the same radius specified by the minimum radius of the drive means. It is, however, also possible that deflection pulley and drive wheel have different radii. Due to the deflection elements, the two strands on the drive side and on the deflection side then are tapered to the same distance from each other.

On the deflection side, the other strand of the drive means advantageously also is guided directly from the deflection pulley into the rail without a deflection element. Like on the drive side, this again provides a considerable reduction of friction losses, as only the one strand is deflected, whereas the other strand directly runs onto the deflection pulley.

Advantageously, in a region adjoining the deflection-side deflection element, a deflection-side separating element furthermore is provided between the two counterrotating strands. Thereby, it again is avoided that the two strands are entangled in the region in which they are guided closer to each other.

Furthermore advantageously, the deflection pulley, the deflection-side deflection element and possibly the deflection-side separating element are arranged in a common housing. This again provides a simple construction and easy assembly, with a receptacle for the rail again being provided here advantageously.

Furthermore advantageously, the deflection pulley for tensioning the drive means is adjustable in accordance with the invention, in particular via an eccentric. In this way, it is possible to increase the distance between drive wheel and deflection pulley upon assembly by adjusting the deflection pulley and thus tension the drive means.

Advantageously, deflection pulley and deflection-side deflection element form a constructional unit, which can be shifted with respect to the housing to which the rail is attached.

Furthermore advantageously, the rail element of the invention includes drive-side connecting elements for connection with a drive motor and deflection-side mounting elements for mounting the rail element. On the drive side, the drive motor thus can be attached e.g. to the housing in which the drive wheel is located, which then is driven by the drive motor. On the deflection side, the rail element e.g. with the housing, in which the deflection pulley is arranged, is attached to the wall of the garage on the lintel side.

Furthermore advantageously, the rail of the rail element of the invention includes a plurality of rail segments to be mounted continuously in longitudinal direction. In this way, the pack size of the rail element can be reduced, wherein the individual rail segments then are connected with each other on the site by connecting elements and form a continuous rail.

Furthermore advantageously, the present invention comprises a premounted assembly of a rail element as described above and a drive motor. Due to the compact construction of the rail element, such drive system can be utilized as a component for various door drives.

Furthermore advantageously, the present invention also comprises a door drive with a rail element as described above, in particular a garage door drive. Such door drive has the same advantages as described already with respect to the rail element.

The present invention now is explained in detail with reference to an embodiment and the drawings, in which:

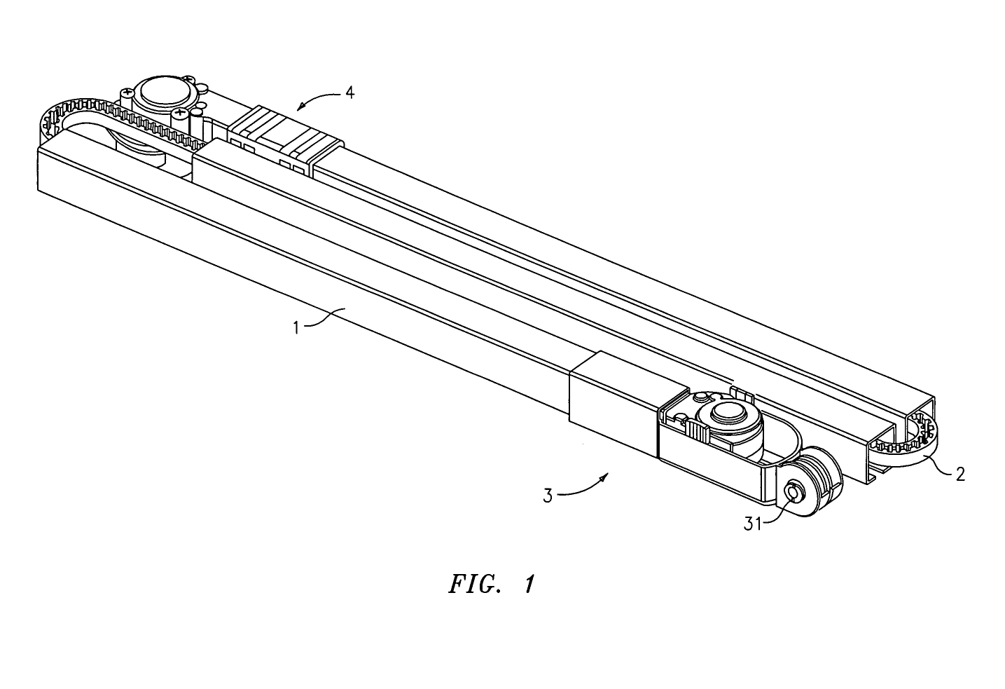

FIG. 1: shows an embodiment of the rail element of the invention in a dismantled condition obliquely from above,

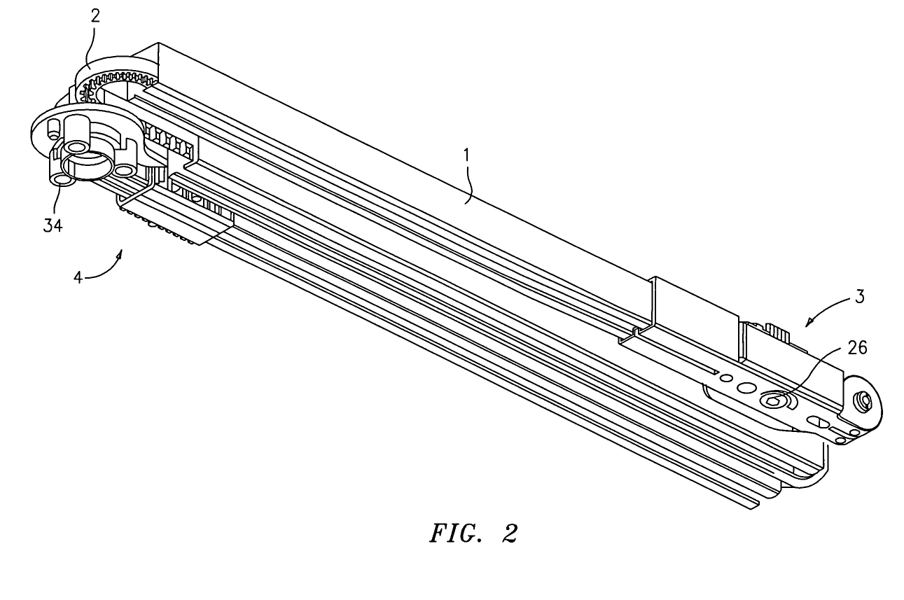

FIG. 2: shows the embodiment of the rail element of the invention in a dismantled condition obliquely from below,

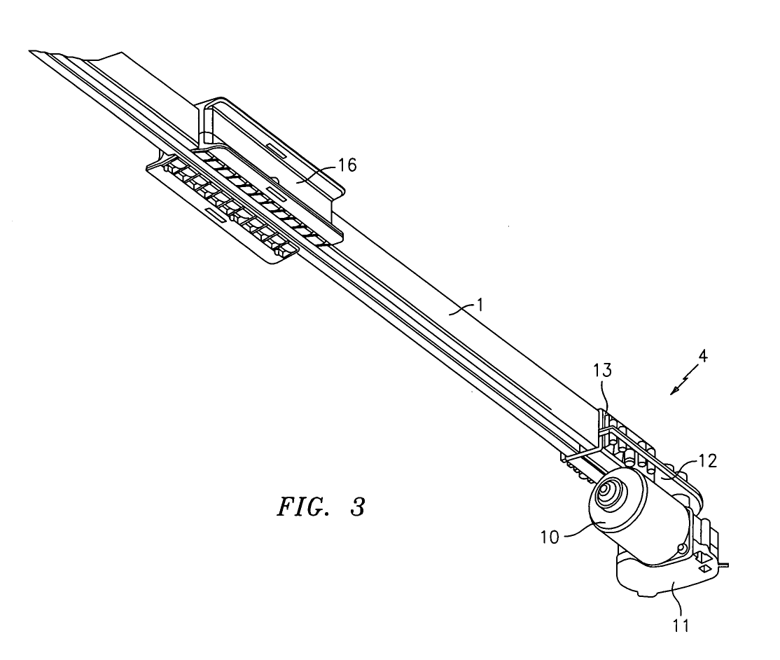

FIG. 3: shows the embodiment of the rail element of the invention in a mounted condition obliquely from below,

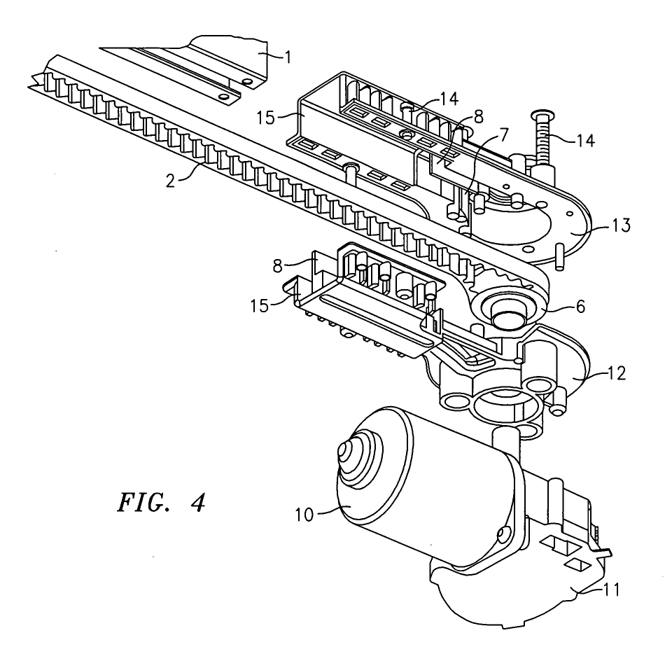

FIG. 4: shows an exploded view of the drive side of the rail element of the invention obliquely from below,

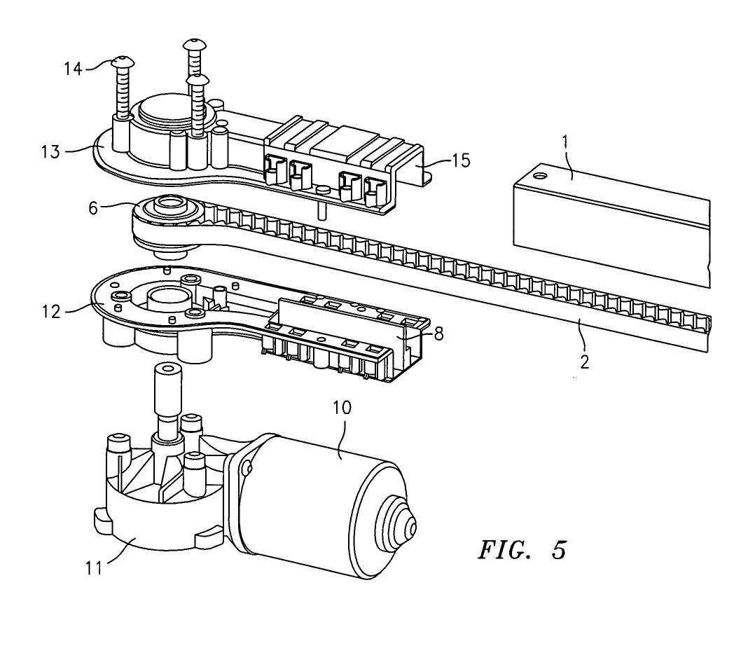

FIG. 5: shows an exploded view of the drive side of the rail element of the invention obliquely from above,

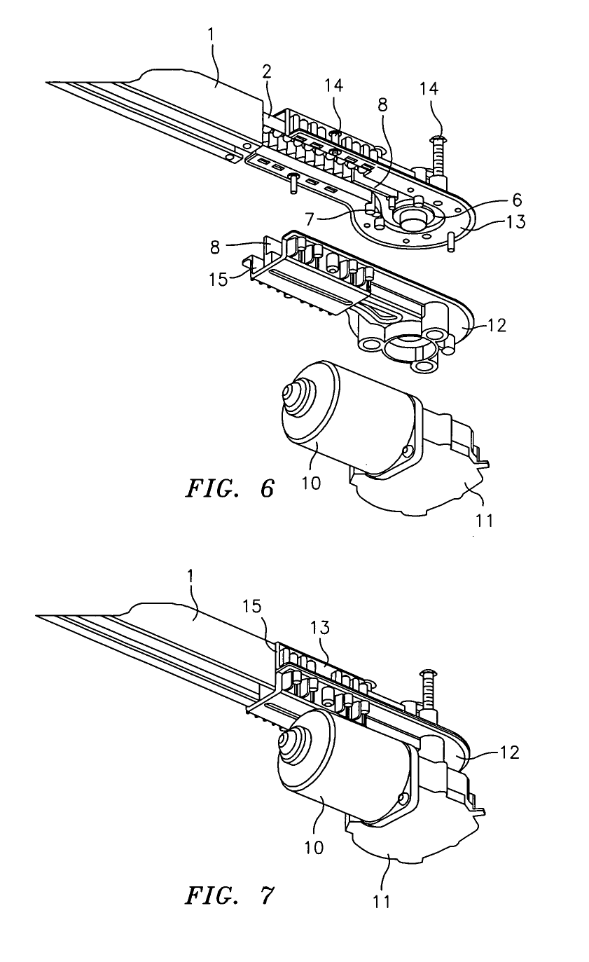

FIG. 6: shows another exploded view of the drive side of the rail element of the invention obliquely from below,

FIG. 7: shows a perspective view of the mounted drive side of the rail element of the invention obliquely from below,

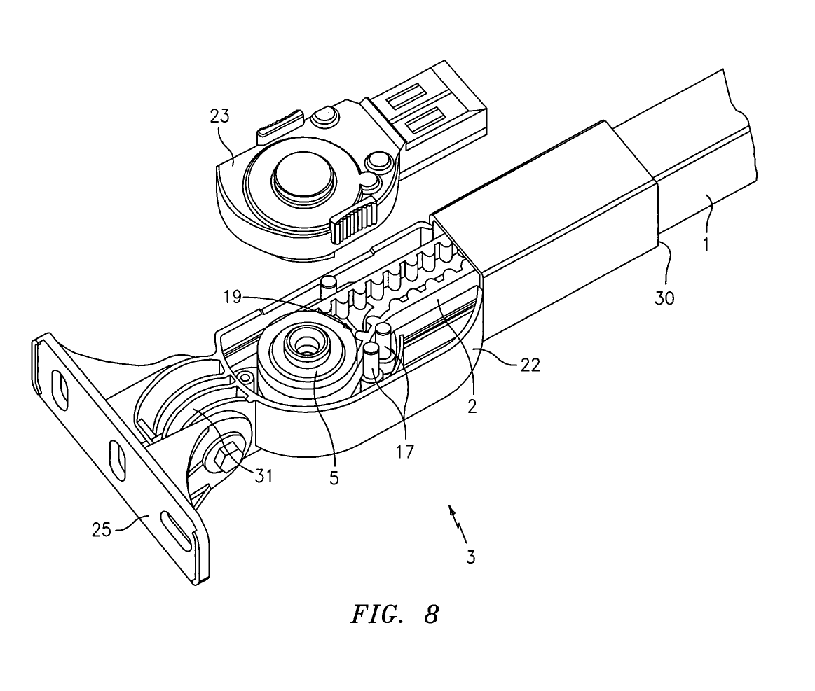

FIG. 8: shows a partial exploded view of the deflection side of the rail element of the invention obliquely from above,

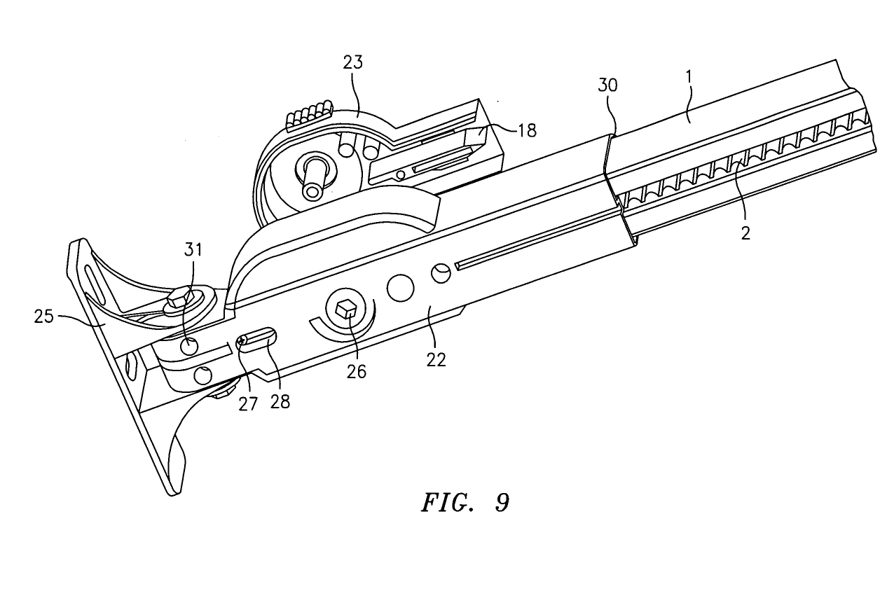

FIG. 9: shows a partial exploded view of the deflection side of the rail element of the invention obliquely from below,

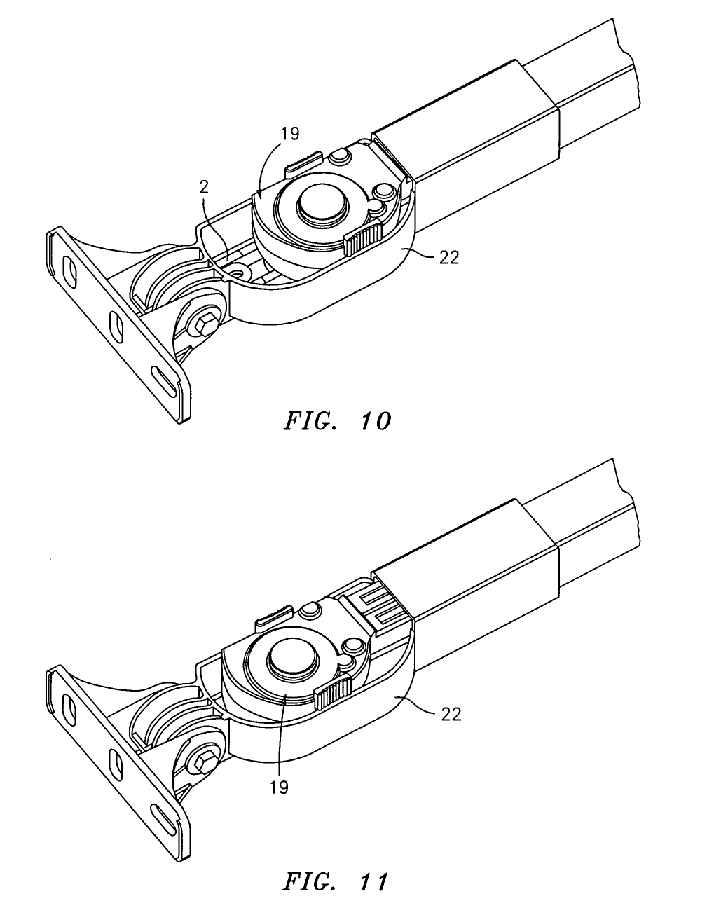

FIG. 10: shows a perspective representation of the deflection side of the rail element of the invention with lid removed in a transport position with slack toothed belt,

FIG. 11: shows the same view as in FIG. 10 in a functional position with untensioned toothed belt,

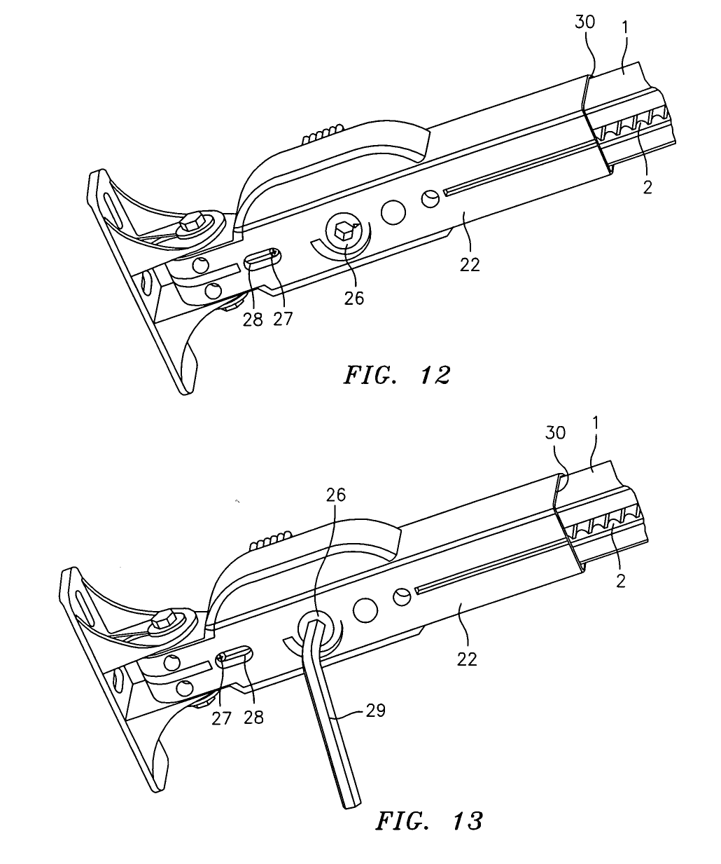

FIG. 12: shows the situation illustrated in FIG. 11 in a view obliquely from below, and

FIG. 13: shows the view of FIG. 12 with tensioned toothed belt.

In FIGS. 1 and 2, the rail element of the invention is illustrated in a transport position, in which the individual rail segments of the rail 1 are not yet connected with each other, so that the drive side 4 connected with a first rail segment, a middle rail segment, and the deflection side 3 connected with a third rail segment can be accommodated one beside the other in the folded condition. The rail segments of the rail 1 of the rail element of the invention have a C-shaped profile. For mounting the rail element illustrated in FIGS. 1 and 2 in the transport position, the individual rail segments of the rail 1 are connected in alignment with each other by a connecting element 16, so that a continuous rail with a C-profile is obtained, at whose one end the circulation side 3 and at whose other end the drive side 4 is arranged. On the drive side 4, a drive unit comprising a motor 10 and a transmission 11 is mounted from below via connecting elements 34, as is shown in FIG. 3.

On the drive side 4, a drive wheel is provided, and on the deflection side 3, a deflection pulley is provided, via which the drive means 2, in this embodiment a toothed belt, is circulated. As usual, the rail element of the invention is arranged horizontally above the door on the ceiling of e.g. a garage, wherein the deflection side 3 is mounted in the vicinity of the door lintel. Then, the rail 1 usually extends parallel to the horizontal guide rails, in which the door leaf or the door leaf elements are guided.

The drive wheel is rotated by a drive motor 10, whereby the drive means 2 performs a circulating movement within the rail, so that the two strands of the drive means 2 extending in parallel within the rail 1 are moved in opposite directions. With one of the two strands, a carriage is connected, which thereby is moved in the rail. The carriage in turn is connected with the door leaf via a cam, so that by a movement of the drive wheel in the one direction the door is opened and by a movement into the other direction the door is closed.

The inventive configuration of the drive side 4 will now be explained in detail with reference to FIGS. 4 to 7. The correspondingly configured deflection side 3 will then be described in detail with reference to FIGS. 8 to 13. The drive side and the deflection side are configured such that the distance of the two strands within the rail can be smaller than the diameter of the drive wheel and of the deflection pulley, which diameters are determined by the minimum bending radius of the toothed belt used as drive means, which provides for the narrow profile of the rail 1.

FIG. 4 now shows the drive side of the embodiment of the rail element of the invention in an exploded view obliquely from below, FIG. 5 obliquely from above. The drive means 2 in the form of a toothed belt extends around the drive wheel 6, which is rotatably mounted in a housing comprising a lower shell 12 and an upper shell 13. The diameter of the drive wheel 6 is greater than the distance of the two counterrotating strands of the drive means within the rail 1. For this purpose, a deflection element 7 is provided on one side of the drive wheel 6, due to which the path of the drive means is tapered. For this purpose, the region of the deflection element which is in contact with the rear side of the drive means has a distance from the imaginary connecting line between the axis of rotation of the drive wheel and the axis of rotation of the deflection pulley, which is smaller than the radius of circulation of the rear side of the drive means about the drive wheel. Such deflection element is provided for only one of the two strands, whereas the other strand is running directly on the drive wheel 6 and whose path in the vicinity of the drive wheel is not influenced by a deflection element.

Due to this asymmetric arrangement of the drive wheel 6 with respect to the centerline of the rail 1, an arrangement is obtained, in which on the one hand a small distance of the two counterrotating strands of the drive means within the rail and hence a very narrow rail profile can be realized, and on the other hand friction losses can be minimized, as a deflection element 7 is provided for only one of the two strands. In this embodiment, the deflection element 7 includes a plurality of sliding pins, on which the rear side of the drive means is sliding along and which deflect the drive means such that the two strands are guided towards each other. Alternatively, a pulley or pulley arrangement might also be used as deflection element 7, on which the rear side of the drive means is running.

Furthermore, separating elements 8 are provided, which in the region of the deflection element and in the adjoining region separate the two strands of the drive means from each other. In the embodiment, a first partial region of the separating element 8 is arranged on the upper shell 13, and a second region on the lower shell 12. In this way, tight side and slack side are separated from each other, so that the teeth of the toothed belt cannot be entangled with each other.

The drive end 3 of the rail element comprises a housing, which is composed of a lower shell 12 and an upper shell 13, which are connected with each other and with the drive unit of drive motor 10 and transmission 11 via connecting screws 14. In the housing, both the drive wheel 6 and the deflection element 7 are mounted and the separating elements 8 are integrated. The housing includes a receptacle 15, in which the profile of the rail 1 is inserted.

FIG. 6 again clearly shows how the toothed belt 2 is directly circulating on the drive wheel 6 with one strand, whereas the other drive strand is deflected by the deflection element 7 in the direction of the first strand, so that the resulting distance between the two strands is smaller than the diameter of the drive wheel 6. Furthermore, the separating element 8 also can be seen between the two strands, which in the region of deflection prevents the two strands from being entangled with each other.

In FIG. 7, the lower shell 12 and the upper shell 13 of the housing now are screwed to each other, and the drive unit of drive motor 10 and transmission 11 is connected with the rail element. In addition, the rail 1 has been inserted into the receptacle 15 and mounted there. The mounted rail element thus can be incorporated in different door drives as one constructional unit with the drive unit.

FIGS. 8 and 9 now show the deflection side 3 of the rail element in a partial exploded view, in which a lid element 23 has been removed from the deflection side. The drive means extends about the deflection pulley 5, and on one side a deflection element 17 in the form of two sliding pins again is provided, on which the rear side of the toothed belt is running and thus is deflected. As a result, the diameter of the deflection pulley 5 is greater than the distance of the two strands of the drive means 2 within the rail. Again, the one strand is running directly on the deflection pulley without deflection elements, whereas the other strand is deflected to the inside. Again, only small friction losses are obtained thereby and nevertheless the narrow configuration of the rail 1 in accordance with the invention.

As shown in FIG. 9, a separating element 18 also is provided between the two strands on the deflection side 3, so that the teeth of the toothed belt 2 cannot be entangled with each other, when they are guided closer to each other in the region of deflection.

There is provided a housing 22, which on one side includes a receptacle 30, in which the rail 1 can be inserted. On the opposite side, the housing includes a mounting element 31, by means of which it can be connected with a wall bracket 25 via an axle. The wall bracket 25 then is mounted above the door on the lintel side.

For tensioning the drive means 2 after mounting the rail element, the deflection pulley 5 can be shifted within the housing 22. For this purpose, the deflection pulley 5, the deflection element 17 and the separating element 18 form a constructional unit 19, which can be shifted inside the housing 22.

In FIG. 10, this constructional unit is shifted maximally in the direction of the rail 1, so that the drive means 2 is lying loosely inside the housing 22. In this position, the rail element can easily be transported. FIG. 11, on the other hand, shows the constructional unit 19 in its mounted position, in which the drive means rests against the deflection pulley, but still is untensioned.

With reference to FIGS. 12 and 13, tensioning the drive means 2 will now be explained in detail. By means of a screw 27, the assembly with the deflection pulley 5 is running in an oblong hole 28 in the housing 22, which extends parallel to the longitudinal direction of the rail 1. Furthermore, an eccentric 26 is rotatably mounted in the housing 22, which can shift the assembly 19 with the deflection pulley in longitudinal direction, when it is rotated as shown in FIG. 13. For this purpose, a hexagon key 29 is necessary in this embodiment, by means of which the eccentric is rotated. A turning handle permanently mounted on the deflection side would also be conceivable here. By rotating the eccentric 26, the deflection pulley is moved away from the drive wheel, so that the drive means 2 is tensioned. The screw 27 then moves along the oblong hole 28. When the drive means 2, however, is tensioned sufficiently, the deflection pulley can be fixed in its position by tightening the screw 27. The rail element of the invention now is ready for operation.

Due to the deflection elements 7 and 17 of the invention, which deflect one strand of the drive means closer towards the other strand, the extremely narrow construction of the rail 1 is possible in accordance with the invention, wherein the asymmetric construction ensures a construction with extremely little friction. In this way, the rail element of the invention is reliable and wear-resistant and due to the narrow rail nevertheless provides for compact drives and compact packages. Moreover, due to the compact construction of the rail, the drive system comprising the rail element and the drive unit can be premounted and be utilized as a component for various door drives.

1. A rail element for a door drive, in particular of a garage door, comprising a rail (1) and a drive means (2), in particular a chain or a toothed belt, wherein at a deflection end (3) of the rail element a deflection pulley (5) and at a drive end (4) of the rail element a drive wheel (6) are provided, via which the drive means (2) is circulated, so that the drive means (2) extends within the rail (1) in two counterrotating strands, and one of the strands of the drive means is guided from the drive wheel (6) via a deflection element (7) into the rail (1), so that the distance of the two counterrotating strands of the drive means within the rail (1) is smaller than the diameter of the drive wheel (6).

2. The rail element according to claim 1, wherein the other strand of the drive means (2) extends directly from the drive wheel (6) into the rail (1) without a deflection element.

3. The rail element according to claim 1, wherein in a region adjoining the deflection element (7) a separating element (8) is provided between the two counterrotating strands.

4. The rail element according to claim 1, wherein the drive wheel (6), the deflection element (7) and possibly the separating element (8) are arranged in a common housing (12, 13).

5. The rail element according to claim 1, wherein one of the strands of the drive means (2) is guided from the deflection pulley (5) via a deflection-side deflection element (17) into the rail (1), so that the distance of the two counterrotating strands of the drive means within the rail (1) is smaller than the diameter of the deflection pulley (5).

6. The rail element according to claim 5, wherein the other strand of the drive means (2) extends directly from the deflection pulley (5) into the rail (1) without a deflection element.

7. The rail element according to claim 5, wherein in a region adjoining the deflection-side deflection element (17) a deflection-side separating element (18) is provided between the two counterrotating strands.

8. The rail element according to claim 5, wherein the deflection pulley (5), the deflection-side deflection element (17) and possibly the deflection side separating element (18) are arranged in a common housing.

9. The rail element according to claim 1, wherein the deflection pulley (5) for tensioning the drive means (2) is adjustable, in particular via an eccentric (26).

10. The rail element according to claim 1, with drive-side connecting elements (34) for connection with a drive motor and with deflection-side mounting elements (31, 25) for mounting the rail element.

11. The rail element according to claim 1, wherein the rail (1) comprises a plurality of rail segments to be mounted continuously in longitudinal direction.

12. A premounted assembly comprising a rail element according to claim 1 and a drive motor (10).

13. A door drive with a rail element according to claim 1, in particular a garage door drive.

14. The rail element according to claim 2, wherein in a region adjoining the deflection element (7) a separating element (8) is provided between the two counterrotating strands.

15. The rail element according to claim 14, wherein the drive wheel (6), the deflection element (7) and possibly the separating element (8) are arranged in a common housing (12, 13).

16. The rail element according to claim 2, wherein the drive wheel (6), the deflection element (7) and possibly the separating element (8) are arranged in a common housing (12, 13).

17. The rail element according to claim 3, wherein the drive wheel (6), the deflection element (7) and possibly the separating element (8) are arranged in a common housing (12, 13).

18. The rail element according to claim 17, wherein one of the strands of the drive means (2) is guided from the deflection pulley (5) via a deflection-side deflection element (17) into the rail (1), so that the distance of the two counterrotating strands of the drive means within the rail (1) is smaller than the diameter of the deflection pulley (5).

19. The rail element according to claim 16, wherein one of the strands of the drive means (2) is guided from the deflection pulley (5) via a deflection-side deflection element (17) into the rail (1), so that the distance of the two counterrotating strands of the drive means within the rail (1) is smaller than the diameter of the deflection pulley (5).

20. The rail element according to claim 15, wherein one of the strands of the drive means (2) is guided from the deflection pulley (5) via a deflection-side deflection element (17) into the rail (1), so that the distance of the two counterrotating strands of the drive means within the rail (1) is smaller than the diameter of the deflection pulley (5).
